(19) United States
(12) Patent Application Publication
(10) Pub. No.: US 2014/0362190 A1
(43) Pub. Date: Dec. 11, 2014

(54) DEPTH MEASUREMENT APPARATUS, IMAGING APPARATUS, AND METHOD OF CONTROLLING DEPTH MEASUREMENT APPARATUS

(71) Applicant: Canon Kabushiki Kaisha, Tokyo (JP)

(72) Inventor: Akinari Takagi, Yokosuka-shi (JP)

(73) Assignee: Canon Kabushiki Kaisha, Tokyo (JP)

(21) Appl. No.: 14/291,611

(22) Filed: May 30, 2014

(30) Foreign Application Priority Data
Jun. 7, 2013 (JP) 2013-121179

(51) Int. Cl. H04N 13/02; H04N 5/357

(52) U.S. Cl. CPC H04N 13/025; H04N 5/357
USPC 348/49

(57) ABSTRACT

A depth measurement apparatus including ranging pixels each having plural photoelectric conversion devices, a reading unit shared by the photoelectric devices, and a control unit for controlling the ranging operation, wherein a signal charge accumulated in one of the photoelectric devices is output as a first signal and a second signal obtained by adding a signal charge accumulated in the other photoelectric device to the first signal is output. In a first mode, the photoelectric device having a stronger signal intensity is used as the first photoelectric device, and the signal charge accumulated in the other photoelectric device is acquired by subtracting the first and second signals subjected to noise reduction. In a second mode, the photoelectric device having a weaker signal intensity is used as the first photoelectric device, and the signal charge accumulated in the other photoelectric device is acquired by subtracting the first and second signals.

### BACKGROUND OF THE INVENTION

1. Field of the Invention

The present invention relates to a depth measurement apparatus for measuring the distance to an object, and particularly relates to a depth measurement apparatus that is used in an imaging apparatus or the like.

2. Description of the Related Art

In a digital still camera or a video camera, proposed is a solid image pickup device in which ranging pixels (depth measurement pixels) with a ranging function are arranged as a part or all of the pixels of the image pickup device, and the distance is detected based on the phase difference system (Japanese Patent Application Publication No. 2001-042462). The ranging pixels include a plurality of photoelectric conversion units. The plurality of photoelectric conversion units are disposed at positions that are substantially optically conjugate with the exit pupil of the camera lens via the microlens in the pixels. It is thereby possible to achieve a configuration where the light flux that has passed through different regions on the pupil of the camera lens can be guided to the respective photoelectric conversion units. Based on the signals obtained with the plurality of photoelectric conversion units disposed in each ranging pixel, an optical image (hereinafter referred to as the “image for ranging”) that is generated from the light flux that has passed through different pupil regions is thereby acquired. The distance can be measured by calculating the de-focus amount using the principle of triangulation based on the shift amount of the two images for ranging. Moreover, an imaging signal can be obtained by totaling the outputs of the plurality of photoelectric conversion units in one pixel.

In addition, in order to speed up the process of acquiring signals, known is a method of sharing a reading unit among the plurality of photoelectric conversion units, and adding and reading the outputs of the plurality of photoelectric conversion units. For example, known is a method of sharing the reading unit between two photoelectric conversion units, transferring the output of the first photoelectric conversion unit to an amplifying element and reading the output, thereafter transferring the output of the second photoelectric conversion unit to the amplifying element, and then reading the output sum of both photoelectric conversion units (Japanese Patent Application Publication No. 2004-134867). The output of the second photoelectric conversion unit is obtained by subtracting the output of the first photoelectric conversion unit from the output sum of both photoelectric conversion units. Consequently, in comparison to the method of individually transferring the output of the respective photoelectric conversion units to the amplifying element and then reading the output, the reading operation can be performed at a high speed since the number of reset operations of the amplifying element can be reduced.

Nevertheless, with the method described in Japanese Patent Application Publication No. 2004-134867, depending on the photographing conditions, there was a problem in that there is a region where the ranging accuracy in the plane of the image pickup device will deteriorate.

Generally speaking, the exit pupil position of the camera lens changes depending on the zoom or focus condition. Meanwhile, the positional relationship of the microlens and the photoelectric conversion unit in the pixel is fixed. Thus, depending on the photographing conditions, there are cases where the photoelectric conversion unit and the exit pupil deviate from a conjugate relation. When deviating from the conjugate relation, the regions on the pupil through which passes the light flux received by the respective photoelectric conversion units of the ranging pixels will differ according to the positions of the respective ranging pixels in the image pickup device. When the area of the light flux received with the respective ranging pixels becomes small on the pupil, the luminance of the detected image for ranging will deteriorate. Thus, the light intensity of the images detected with the respective photoelectric conversion units in the ranging pixels will differ according to the positions of the respective ranging pixels in the image pickup device.

Meanwhile, when the photoelectric conversion unit output is obtained based on subtraction, the SN ratio of the output signal (image signal for ranging) is low since the generation of random noise differs in comparison to the case of independently reading the photoelectric conversion unit output.

Even though the detected light intensity differed according to the positions of the ranging pixels in the image pickup device, conventionally, the output signal of the photoelectric conversion units of the same positional relationship in the ranging pixels was constantly read independently. Thus, there are cases where the photoelectric conversion unit with low detected light intensity and the photoelectric conversion unit (photoelectric conversion unit in which the output is obtained based on subtraction), which has a low SN ratio due to the subtraction, coincide, and the SN ratio of the image signal for ranging based on the output of this photoelectric conversion unit will deteriorate considerably. When the SN ratio of the image signal for ranging deteriorates, the reading error of the image deviation will increase, and the ranging accuracy will deteriorate. Since the detected light intensity depends on the positions of the respective ranging pixels in the image pickup device, there are regions on the plane of the image pickup device with a low ranging accuracy.

Note that, even in cases where the conjugate relation of the photoelectric conversion unit and the exit pupil of the camera lens is maintained, when there is shading of the light flux, or vignetting, in the lens frame, the detected light intensity will differ depending on the positions of the ranging pixels in the image pickup device. The change in light intensity will increase and the ranging accuracy will consequently deteriorate depending on the aperture diameter of the camera lens and the foregoing photographing conditions.

### SUMMARY OF THE INVENTION

In light of the foregoing problems, an object of this invention is to provide a depth measurement apparatus capable of accurately performing ranging in the entire range of the image pickup device regardless of the photographing conditions.

The first aspect of the present invention is a depth measurement apparatus, comprising: an imaging optical system; an image pickup device which includes ranging pixels each having a photoelectric conversion unit for receiving a light flux that has passed through a first pupil region of the imaging optical system and a photoelectric conversion unit for receiving a light flux that has passed through a second pupil region, that is different from the first pupil region, of the imaging optical system a reading unit that is shared by a plurality of photoelectric conversion units in the ranging pixels; and control unit configured to control the ranging operation, wherein the control unit is configured so that a signal charge accumulated in a first photoelectric conversion unit among the plurality of photoelectric conversion units is transferred to the reading unit, and a first signal corresponding to the signal charge accumulated in the first photoelectric conversion unit is output, the control unit is configured so that a signal charge accumulated in a second photoelectric conversion unit that is different from the first photoelectric conversion unit is transferred and added to the reading unit, and a second signal corresponding to a sum of the signal charges accumulated in the first and second photoelectric conversion units is output, a first transfer mode and a second transfer mode are selectable and the first and second signals are each output in one of the transfer modes, the first transfer mode being a mode in which, from among the photoelectric conversion unit for receiving the light flux that has passed through the first pupil region and the photoelectric conversion unit for receiving the light flux that has passed through the second pupil region, the photoelectric conversion unit receiving light flux with a higher transmittance in a travel path from an object to the photoelectric conversion unit is used as the first photoelectric conversion unit, and the second transfer mode being a mode in which the photoelectric conversion unit receiving light flux with a lower transmittance is used as the first photoelectric conversion unit, the control unit is configured so that when the first transfer mode is selected, a first image signal obtained by performing noise reduction processing to an image signal generated from the first signal and a second image signal obtained by performing noise reduction processing to an image signal generated from the second signal are generated, and a third image signal corresponding to the signal charge accumulated in the second photoelectric conversion unit is generated by subtracting the first image signal from the second image signal, the control unit is configured so that when the second transfer mode is selected, a third signal corresponding to the signal charge accumulated in the second photoelectric conversion unit is generated based on a difference between the second signal and the first signal, a first image signal is generated from the first signal, and a third image signal is generated from the third signal, and a distance to the object is measured based on an image shift amount between the first image signal and the third image signal.

The second aspect of the present invention is an imaging apparatus comprising the depth measurement apparatus described above, wherein the imaging apparatus acquiring an object image based on the second signal.

The third aspect of the present invention is a method of controlling a depth measurement apparatus comprising: an imaging optical system; an image pickup device which includes ranging pixels each having a photoelectric conversion unit for receiving a light flux that has passed through a first pupil region of the imaging optical system and a photoelectric conversion unit for receiving a light flux that has passed through a second pupil region, that is different from the first pupil region, of the imaging optical system; and a reading unit that is shared by a plurality of photoelectric conversion units in the ranging pixels, the method comprising the steps of: transferring a signal charge accumulated in a first photoelectric conversion unit among the plurality of photoelectric conversion units to the reading unit, and outputting a first signal corresponding to the signal charge accumulated in the first photoelectric conversion unit; and transferring and adding a signal charge accumulated in a second photoelectric conversion unit that is different from the first photoelectric conversion unit to the reading unit, and outputting a second signal corresponding to a sum of the signal charges accumulated in the first and second photo electric conversion units, a first transfer mode and a second transfer mode being selectable, the first transfer mode being a mode in which, from among the photoelectric conversion unit for receiving the light flux that has passed through the first pupil region and the photoelectric conversion unit for receiving the light flux that has passed through the second pupil region, the photoelectric conversion unit receiving light flux with a higher transmittance in a travel path from an object to the photoelectric conversion unit is used as the first photoelectric conversion unit, and the second transfer mode being a mode in which the photoelectric conversion unit receiving light flux with lower transmittance is used as the first photoelectric conversion unit, the method further comprising the steps of: determining the transfer mode upon outputting the first and second signals; generating a first image signal obtained by performing noise reduction processing to an image signal generated from the first signal and a second image signal obtained by performing noise reduction processing to an image signal generated from the second signal, and generating a third image signal corresponding to the signal charge accumulated in the second photoelectric conversion unit by subtracting the first image signal from the second image signal when the first transfer mode is selected; generating a third signal corresponding to the signal charge accumulated in the second photoelectric conversion unit based on a difference between the second signal and the first signal, generating a first image signal from the first signal, and generating a third image signal from the third signal when the second transfer mode is selected; and measuring a distance to the object based on an image shift amount between the first image signal and the third image signal.

Further features of the present invention will become apparent from the following description of exemplary embodiments with reference to the attached drawings.

### BRIEF DESCRIPTION OF THE DRAWINGS

FIG. 1 is a configuration example of the camera comprising the depth measurement apparatus according to Embodiment 1;

FIGS. 2A and 2B are cross sections of the relevant part of the ranging pixels included in the image pickup device;

FIG. 3 is a diagram explaining the relationship of the exit pupil and the ranging pixels;

FIG. 4 is a top view of the relevant part of the image pickup device in Embodiment 1;

FIGS. 5A to 5I are diagrams explaining the reason why signals of a high SN ratio can be obtained in Embodiment 1;

FIG. 6 is a flowchart showing the flow of the ranging processing in Embodiment 1;

FIG. 7 is a diagram explaining that the exit pupil position will change based on a zoom;

FIG. 8 is a top view of the relevant part of the image pickup device in Embodiment 2;

FIGS. 9A to 9I are diagrams explaining the reason why signals of a high SN ratio can be obtained in Embodiment 2;

FIG. 10 is a diagram explaining an example of the pixel region division in Embodiment 2; and

FIG. 11 is a flowchart showing the flow of the ranging processing in Embodiment 2.

### DESCRIPTION OF THE EMBODIMENTS

The depth measurement apparatus according to an embodiment of the present invention is now explained with reference to the drawings. The components having the same functions in all diagrams are given the same reference numeral, and the redundant explanation thereof is omitted.

### Embodiment 1

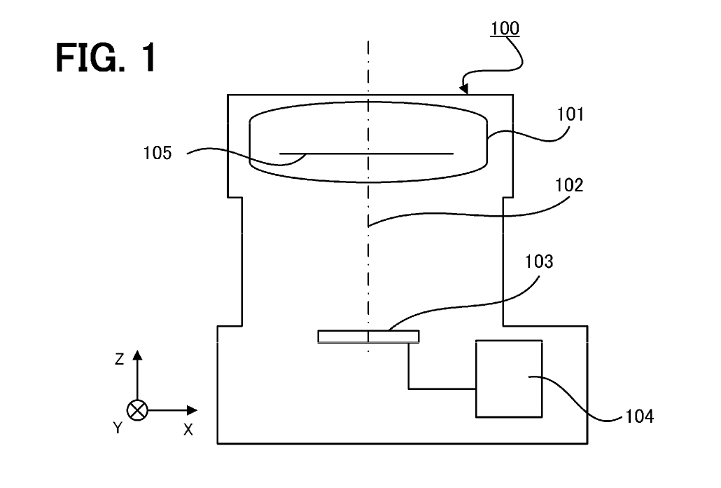

A configuration example of a digital camera 100 (imaging apparatus) including the depth measurement apparatus of this embodiment is shown in FIG. 1. In FIG. 1, the digital camera 100 is configured from a taking lens 101, an image pickup device 103, and a control unit 104. The image pickup device 103 is disposed on an optical axis 102 of the taking lens 101, and the taking lens 101 forms an image of an object on the image pickup device 103. Reference numeral 105 represents an exit pupil of the taking lens 101.

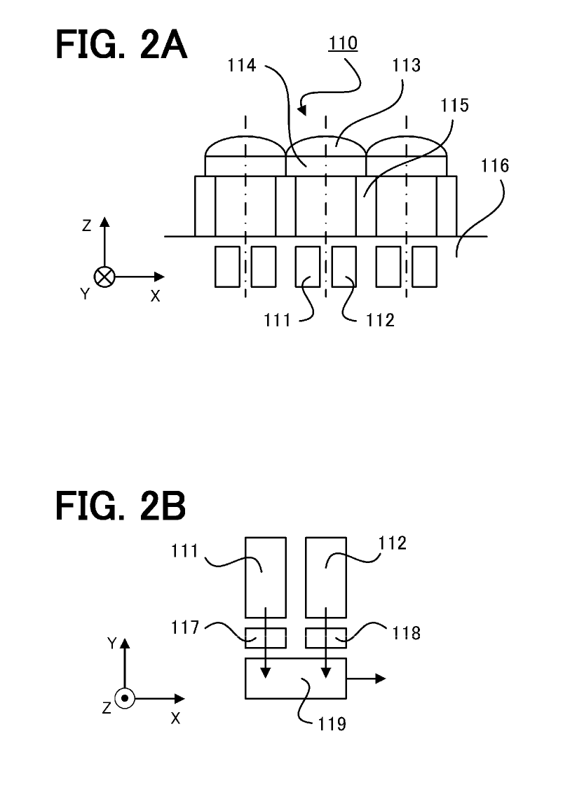

FIG. 2 is a cross section of the relevant part of a ranging pixel (depth measurement pixel) 110 included in the image pickup device (image sensor) 103. As shown in FIG. 2A, the ranging pixel 110 is configured from a microlens 113, a color filter 114, a wiring part 115, and photoelectric conversion units 111 and 112 formed in a silicon substrate 116. Light that enters from the microlens 113 passes through the color filter 114, passes through the wiring part 115 disposed between the pixels, and enters the photoelectric conversion units 111 and 112. The light that entered the photoelectric conversion units 111 and 112 is subjected to photoelectric conversion and generates a signal charge according to the intensity of the incident light. The generated signal charge is accumulated in the photoelectric conversion units 111 and 112.

As shown in FIG. 2B, the signal charge accumulated in the photoelectric conversion unit 111 is transferred to an amplifying/reading unit 119 via a gate 117 and then output. Moreover, the signal charge accumulated in the photoelectric conversion unit 112 is transferred to the amplifying/reading unit 119 via a gate 118 and then output. The amplifying/reading unit 119 can read either signal charge from the photoelectric conversion units 111 and 112. In other words, one amplifying/reading unit 119 is shared by two photoelectric conversion units 111 and 112 in one ranging pixel.

The control unit 104 is configured from an ASIC, a microprocessor, a memory and the like, and controls the ranging operation including the reading of the signal charge from the photoelectric conversion unit, for example, by the microprocessor executing the programs stored in the memory. In the ensuing explanation, the signal reading method of the control unit 104 is explained by taking a case of first outputting a signal corresponding to the signal charge accumulated in the photoelectric conversion unit 111 as an example. The control unit 104 resets the reading unit 119 and thereafter opens the gate 117, and transfers the signal charge accumulated in the photoelectric conversion unit 111 to the amplifying/reading unit 119 (reading unit). After the transfer, a signal (first signal) corresponding to the signal charge accumulated in the photoelectric conversion unit 111 is output, then stored in the memory.

Subsequently, the control unit 104 opens the gate 118, and transfers the signal charge accumulated in the photoelectric conversion unit 112 to the amplifying/reading unit 119 (reading unit). After the transfer is complete, a signal (second signal) obtained by addition of the signal charge transferred from the photoelectric conversion unit 112 is output in addition to the first signal, and then stored in the memory. Note that, in order to eliminate the kTC noise that is generated upon resetting the amplifying/reading unit, known noise elimination operations such as correlated double sampling may also be performed. More specifically, prior to opening the gate 117, the reset level signal from the amplifying/reading unit may be output and stored, and the reset level may be subtracted from the signals that are read in the subsequent operations to attain the respective signals.

The subsequent processing differs according to the transfer mode. In this embodiment, two transfer modes are selectable. In the case of the first transfer mode, the control unit 104 generates an image signal from the first signal of the plurality of ranging pixels 110, and performs noise reduction processing to this image signal in order to generate a first image signal. In addition, the control unit 104 generates an image signal from the second signal of the plurality of ranging pixels 110, and performs noise reduction processing to this image signal in order to generate a second image signal. Moreover, the control unit 104 subtracts the first image signal from the second image signal and generates a third image signal corresponding to the signal charge accumulated in the photoelectric conversion unit 112 of the plurality of ranging pixels 110.

Meanwhile, in the case of the second transfer mode, the control unit 104 generates a third signal corresponding to the signal charge accumulated in the second photoelectric conversion unit, generates a first image signal from the first signal, and generates a third image signal from the third signal based on a difference between the second signal and the first signal.

In the ensuing explanation, the photoelectric conversion unit (photoelectric conversion unit 111 in the foregoing example) from which the signal charge is to be read first is referred to as the first photoelectric conversion unit. Moreover, the photoelectric conversion unit (photoelectric conversion unit 112 in the foregoing example) from which the signal charge is to be read subsequently is referred to as the second photoelectric conversion unit.

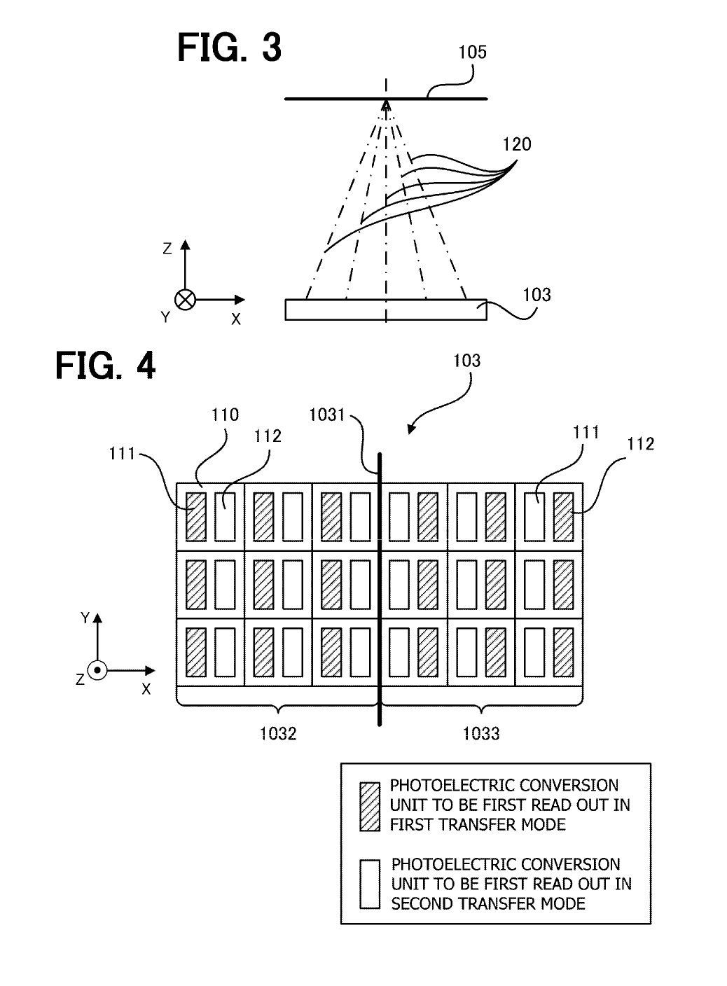

The photoelectric conversion units 111 and 112 of all ranging pixels 110 included in the image pickup device 103 are of an optical conjugate relation with the exit pupil 105 of the taking lens 101 based on the microlens 113 of the respective ranging pixels 110. Here, as shown in FIG. 3, the center point of the line segment connecting the respective center points of the photoelectric conversion unit 111 and the photoelectric conversion unit 112 optically coincides with the center point of the exit pupil 105 of the taking lens 101. In FIG. 3, the optical axes 120 are line segments that pass through the center point of the line segment connecting the respective center points of the photoelectric conversion unit 111 and the photoelectric conversion unit 112 in the respective ranging pixels 110 in the image pickup device 103, and through the center point of the microlens 113 of the respective ranging pixels 110. The optical axes 120 of the respective ranging pixels 110 all pass through the center point of the exit pupil 105.

Based on the foregoing arrangement, the photoelectric conversion unit 111 receives the light flux that has passed through the region (first pupil region) that is decentered to one side from the center point of the exit pupil 105. Moreover, the photoelectric conversion unit 112 receives the light flux that has passed through the region (second pupil region) that is decentered to a side that is opposite to the first pupil region from the center point of the exit pupil 105. The control unit 104 acquires the object image (first image signal) based on the light flux that has passed through the first pupil region based on the output signal (first signal) of the photoelectric conversion unit 111 of the plurality of ranging pixels 110 in the image pickup device 103. Moreover, the control unit 104 acquires the object image (third image signal) based on the light flux that has passed through the second pupil region based on the output signal (second signal) and the first signal of the photoelectric conversion units 111 and 112 of the plurality of ranging pixels 110. Since the position of the first pupil region and the position of the second pupil region are different, the two acquired object images are subjected to parallax. Thus, by obtaining the displacement (image deviation, or image shift amount) of the two object images, the distance to the object can be obtained by using the principle of triangulation.

Moreover, the second signal is the sum of the signal charges accumulated in the photoelectric conversion unit 111 and the photoelectric conversion unit 112. The control unit 104 acquires, based on the second signal, the object image (second image signal) based on the light flux that has passed through the pupil region as the sum of the first pupil region and the second pupil region; that is, the entire range of the exit pupil 105.

FIG. 4 is a top view of the relevant part of the image pickup device 103. As shown in FIG. 4, the image pickup device 103 is configured by the plurality of ranging pixels 110 being arranged two-dimensionally. Each of the ranging pixels 110 is configured from the photoelectric conversion unit 111 and the photoelectric conversion unit 112. The photoelectric conversion units 111 and 112 are arranged in the same direction in all ranging pixels 110. The photoelectric conversion unit 111 is disposed on the negative direction side of the x axis in one ranging pixels 110, and the photoelectric conversion unit 112 is disposed on the positive direction side of the x axis. Note that the straight line (x axis) connecting the center points of the photoelectric conversion units 111 and 112 is parallel to the extending direction of the straight line connecting the center of gravity of the pupil region (first pupil region) through which passes the light flux received by the photoelectric conversion unit 111 and the center of gravity of the pupil region (second pupil region) through which passes the light flux received by the photoelectric conversion unit 112.

For the sake of convenience, in the ensuing explanation, the x axis positive direction in FIG. 4 is also referred to as the right direction, and the x axis negative direction is also referred to as the left direction. Accordingly, it can also be said that the photoelectric conversion unit 111 is disposed on the left side in the ranging pixels 110, and the photoelectric conversion unit 112 is disposed on the right side in the ranging pixels 110. Moreover, it can also be said that the photoelectric conversion unit 111 receives the light flux that has passed through the region (first pupil region) that is decentered to the right from the center point of the exit pupil 105, and the photoelectric conversion unit 112 receives the light flux that has passed through the region (second pupil region) that is decentered to the left from the center point of the exit pupil 105.

In FIG. 4, the shaded photoelectric conversion unit is the photoelectric conversion unit (first photoelectric conversion unit) from which the signal is first read during the first transfer mode. Contrarily, the non-shaded photoelectric conversion unit is the photoelectric conversion unit (first photoelectric conversion unit) from which the signal is first read during the second transfer mode. In the respective transfer modes, from which photoelectric conversion units 111 and 112 the signal should be read first will differ in the image pickup device region 1032 (second image pickup device region) and the image pickup device region 1033 (first image pickup device region).

The image pickup device region 1032 and the image pickup device region 1033 are disposed across a line segment 1031 as a boundary line. The line segment 1031 is a line segment that passes through the center of the image pickup device 103, and is perpendicular to the direction that connects the center point of the photoelectric conversion unit 111 and the center point of the photoelectric conversion unit 112 in one pixel. To put it differently, when the extending direction of the straight line that passes through the center of gravity of the first pupil region and the center of gravity of the second pupil region is a first direction, the line segment 1031 is a line segment that passes through the center of the image pickup device and is perpendicular to the direction on the image pickup device corresponding to the first direction.

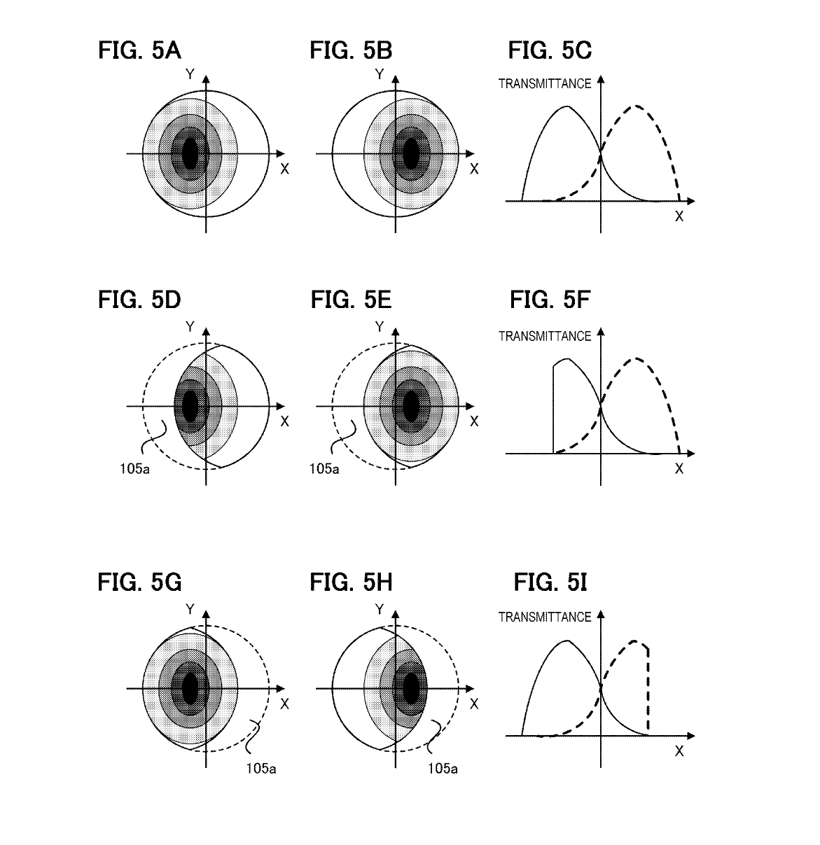

FIG. 5A represents the pupil transmittance distribution on the exit pupil 105 corresponding to the photoelectric conversion unit 112 in the ranging pixels 110 disposed near the center of the image pickup device 103, and corresponds to the left eccentric pupil region (second pupil region). In the diagram, the darker the color, the higher the transmittance, and lighter the color, the lower the transmittance. Similarly, FIG. 5B represents the pupil transmittance distribution on the exit pupil 105 corresponding to the photoelectric conversion unit 111 in the ranging pixels 110 disposed near the center of the image pickup device 103, and corresponds to the right eccentric pupil region (first pupil region). FIG. 5C represents the transmittance distribution on the x axial plane, and the horizontal axis shows the x axial coordinates and the vertical axis shows the transmittance. The solid line shows the transmittance distribution corresponding to the photoelectric conversion unit 112 (corresponding to the right eccentric pupil region), and the dotted line shows the transmittance distribution corresponding to the photoelectric conversion unit 111 (corresponding to the left eccentric pupil region). The pupil transmittance distribution is determined based on the positional relationship of the photoelectric conversion units, the microlens and the exit pupil, the aberration and diffraction of the microlens, and the light propagation status such as the light scattering and absorption in the light path from the incident surface of the image pickup device to the photoelectric conversion unit. Thus, the transmission efficiency of the light flux in a travel path from the object to the photoelectric conversion unit 111, 112 in the ranging pixels 110 will differ.

The transmission efficiency in the respective pupil regions can be obtained by integrating the transmittance distribution in the exit pupil 105 shown in FIGS. 5A and 5B. With the ranging pixels 110 disposed near the center of the image pickup device 103, the transmission efficiency of the right eccentric pupil region and the transmission efficiency of the left eccentric pupil region are substantially the same. Thus, the size of the object picture signals based on the light flux that passes through the respective pupil regions is substantially the same.

FIG. 5D represents the pupil transmittance distribution on the exit pupil 105 corresponding to the photoelectric conversion unit 112 in the ranging pixels 110 of the image pickup device region 1032, and corresponds to the left eccentric pupil region (second pupil region). FIG. 5E represents the pupil transmittance distribution on the exit pupil 105 corresponding to the photoelectric conversion unit 111 in the ranging pixels 110 of the image pickup device region 1032, and corresponds to the right eccentric pupil region (first pupil region). FIG. 5F represents the transmittance distribution on the x axial plane. Generally speaking, so-called vignetting where the light flux becomes shaded at the lens frame due to demands for the miniaturization of the imaging lens occurs in the peripheral imaged height, and the light flux that has passed through the diaphragm is never entirely guided to the image pickup device. Since vignetting occurs from one side on the pupil, the variation in the transmission efficiency will differ according to the shape of the original transmittance distribution. As shown in FIG. 5D, when a region 105a where vignetting occurs coincides with a region in which the original transmittance is high, the amount of decrease in the transmission efficiency will be great. Meanwhile, as shown in FIG. 5E, when a region 105a where vignetting occurs coincides with a region in which the original transmittance is low, the amount of decrease in the transmission efficiency will be small. Thus, with the ranging pixels 110 of the image pickup device region 1032, the transmission efficiency of the right eccentric pupil region will be a value that is higher than the transmission efficiency of the left eccentric pupil region. In other words, the picture signal based on the light flux that has passed through the right eccentric pupil region will be greater than the picture signal based on the light flux that has passed through the left eccentric pupil region.

FIG. 5G represents the pupil transmittance distribution on the exit pupil 105 corresponding to the photoelectric conversion unit 112 in the ranging pixels 110 of the image pickup device region 1033, and corresponds to the left eccentric pupil region (second pupil region). FIG. 5H represents the pupil transmittance distribution on the exit pupil 105 corresponding to the photoelectric conversion unit 111 in the ranging pixels 110 of the image pickup device region 1033, and corresponds to the right eccentric pupil region (first pupil region). FIG. 5I represents the transmittance distribution on the x axial plane. Similarly, with the ranging pixels 110 of the image pickup device region 1033, the transmission efficiency of the left eccentric pupil region will be a value that is higher than the transmission efficiency of the right eccentric pupil region. Thus, the picture signal based on the light flux that has passed through the left eccentric pupil region will be greater than the picture signal based on the light flux that has passed through the right eccentric pupil region.

Noise, particularly random noise, that is generated in the picture signal of the image pickup device is now explained. Dominant random noises are a photon shot noise Ns and a reading circuit noise Nr. The photon shot noise is generated during photoelectric conversion, and the level thereof depends on the size of the signal, and is the square root of the signal size (Ns=S^{1/2}). Meanwhile, the reading circuit noise is generated during the output from the reading unit, is not dependent on the size of the signal, is determined based on the manufacturing condition of the image pickup device, and takes on a constant value (Nr=const). Since the photon shot noise and the reading circuit noise are independent phenomena, the total value of noise will be the square root of the sum of squares. When the signal component in the picture signal is S and the reading circuit noise component is Nr, the SN ratio of the first signal is expressed as shown in Formula 1.

$$\begin{matrix}[ Math . 1 ] & \\ {SN}_{1} = \frac{{S}_{1}}{\sqrt{{S}_{1} + {N}_{r}^{2}}} & Formula 1\end{matrix}$$

Similarly, the SN ratio of the second signal is expressed as shown in Formula 2.

$$\begin{matrix}[ Math . 2 ] & \\ {SN}_{2} = \frac{{S}_{2}}{\sqrt{{S}_{2} + {N}_{r}^{2}}} & Formula 2\end{matrix}$$

A signal corresponding to the signal charge accumulated in the second photoelectric conversion unit is used as the third signal. The third signal is obtained by subtracting the first signal from the second signal. The signal component in the third signal will be the difference between the signal component in the second signal and the signal component in the first signal. Since the reading circuit noise is independently generated when the first signal is output and when the second signal is output, it becomes the square root of the sum of squares. Meanwhile, the photon shot noise component in the second signal is a result of the photon shot noise component of the signal charge transferred to the reading unit subsequently being added to the photon shot noise component in the first signal. Thus, the photon shot noise component in the third signal is the square root of the difference between the signal component in the second signal and the signal component in the first signal. Accordingly, the SN ratio of the third signal is expressed as shown in Formula 3.

$$\begin{matrix}[ Math . 3 ] & \\ {SN}_{3} = \frac{{S}_{2} - {S}_{1}}{\sqrt{{S}_{2} - {S}_{1} + 2 {N}_{r}^{2}}} & Formula 3\end{matrix}$$

Upon comparing Formula 1 and Formula 3, it can be seen that the photoelectric conversion unit that first transferred the signal charge to the reading unit can output signals with a more favorable SN ratio in comparison to the photoelectric conversion unit that transferred the signal charge subsequently. When the level of the signal component is great, since the photon shot noise is more dominant than the reading circuit noise (S>>Nr²), the difference in the SN ratio between the first signal and the third signal is small. Nevertheless, when the object is dark and the signal component is great, the influence of the reading circuit noise increases relatively (S˜Nr²), and deterioration in the signal quality is considerable. When the SN ratio of the image signal used in ranging deteriorates, the reading error of the image deviation increases, and the ranging accuracy deteriorates.

When the size of the signal component is fixed, there are two methods for reducing the noise component, and increasing the SN ratio of the signal. The first method is to reduce the noise component as much as possible upon acquiring the signal. The second method is to reduce the noise component by performing statistical processing such as averaging to the time direction or the spatial direction.

When the amount of the original noise component is great, the noise reduction effect based on the statistical processing will relatively be small. This is because the amount of decrease in the noise component will differ depending on the number of signals that are used in the statistical processing, and the amount of noise reduction will be small when the number of signals is few. In the foregoing case, the method of reducing the noise component upon acquiring the signal is effective. In other words, preferably, from the photoelectric conversion unit with a small signal of which the SN ratio would be considerably degraded by the reading circuit noise if calculated by the subtraction, the signal charge is first transferred to the reading unit in order to avoid the reduction in the SN ratio caused by the reading circuit noise when the subtraction. It is thereby possible to acquire a parallax image with a high SN ratio.

Meanwhile, when the amount of the original noise component is small, the noise reduction effect based on the statistical processing will relatively be great. In the foregoing case, the method of reducing the noise component via statistical processing is effective. In other words, preferably, the signal charge of the photoelectric conversion unit with a great signal component is first transferred to the reading unit in order to increase the SN ratio of the signal. It is thereby possible to increase the reliability of processing and, since the effect of the noise reduction processing is high, a parallax image with a high SN ratio can be acquired.

Accordingly, it is possible to select a method that can appropriately increase the SN ratio of the signal depending on the size of the original signal, and constantly acquire a parallax image with a high SN ratio.

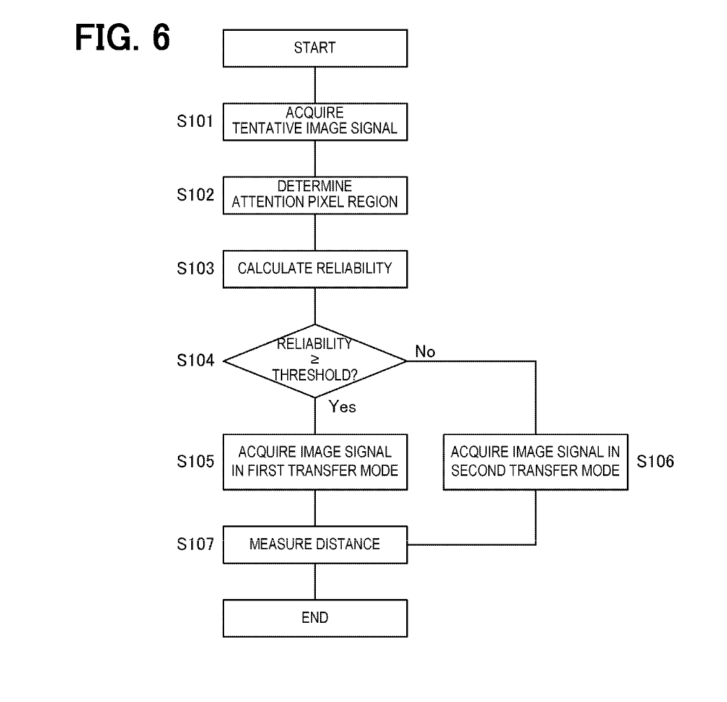

The processing flow of this embodiment is now explained with reference to FIG. 6. Foremost, in step S101, the signals (tentative image signals) corresponding to the signal charge of the photoelectric conversion units 111 and 112 are tentatively acquired. While the transfer mode in this case may be arbitrarily selected, in this embodiment, the first image signal and the third image signal are acquired from the photoelectric conversion unit of the ranging pixels in the second transfer mode. In step S102, the control unit 104 determines the attention pixel region including the main object from the object image based on the tentative image signals. In step S103, the control unit 104 extracts, as the reliability, the value of the greater signal intensity of either the signal intensity of the first image signal or the signal intensity of the third image signal corresponding to the attention pixel region. In step S104, the control unit 104 determines whether the reliability is a predetermined threshold or higher (S104). When the reliability is the threshold or higher (S104—YES), since the signal intensity is great and the noise reduction effect based on the statistical processing is great, the first transfer mode is determined as the transfer mode for distance measurement. In other words, the control unit 104 acquires the first image signal and the third image signal from the photoelectric conversion units of the ranging pixels in the entire range of the image pickup device based on the first transfer mode (S105). Meanwhile, when the reliability is less than the threshold (S104—NO), since the signal intensity is weak and the noise reduction effect based on the statistical processing is small, the second transfer mode is selected as the transfer mode for distance measurement. In other words, the control unit 104 acquires the first image signal and the third image signal from the photoelectric conversion units of the ranging pixels in the entire range of the image pickup device based on the second transfer mode (S106). Subsequently, in step S107, the control unit 104 calculates the image deviation from the first image signal and the third image signal, and thereby measures the distance to the object.

The predetermined threshold used in the determination of step S104 is now explained in further detail. The ultimately required SN ratio (target value) is obtained from the required ranging accuracy. Moreover, the level of improvement of the SN ratio is determined based on the number of signals that can be used in the statistical processing. In addition, the value obtained by subtracting the level of improvement from the statistical processing from the target value of the SN ratio becomes the tolerable SN ratio, and the required signal intensity is determined based thereon. This signal intensity becomes the threshold to be used in the reliability determination. Note that the number of signals that can be used in the statistical processing is determined based on restrictions in the calculation time or calculation load required for the ranging. In step S103, the greater signal intensity average value of the respective signal intensity average values of the first image signal and the third image signal of all ranging pixels in the attention pixel region is extracted and used as the reliability.

In the first transfer mode, with regard to the image pickup device region 1032 of FIG. 4, the signal charge accumulated in the photoelectric conversion unit 111 is first transferred to the reading unit, and then output. In other words, in the image pickup device region 1032 where the transmission efficiency of the first pupil region is higher than the transmission efficiency of the second pupil region, the signal charge of the photoelectric conversion unit 111 for receiving the light flux that has passed through the first pupil region is first transferred to the reading unit 119, and then output. Meanwhile, in the image pickup device region 1033, the signal charge accumulated in the photoelectric conversion unit 112 is first transferred to the reading unit, and then output. In other words, in the image pickup device region 1033 where the transmission efficiency of the second pupil region is higher than the transmission efficiency of the first pupil region, the signal charge of the photoelectric conversion unit 112 for receiving the light flux that has passed through the second pupil region is first transferred to the reading unit 119, then output.

In the second transfer mode, with regard to the image pickup device region 1032 of FIG. 4, the signal charge accumulated in the photoelectric conversion unit 112 is first transferred to the reading unit, and then output. In other words, in the image pickup device region 1032 where the transmission efficiency of the second pupil region is lower than the transmission efficiency of the first pupil region, the signal charge of the photoelectric conversion unit 112 for receiving the light flux that has passed through the second pupil region is first transferred to the reading unit 119, and then output. Meanwhile, in the image pickup device region 1033, the signal charge accumulated in the photoelectric conversion unit 111 is first transferred to the reading unit, and then output. In other words, in the image pickup device region 1033 where the transmission efficiency of the first pupil region is lower than the transmission efficiency of the second pupil region, the signal charge of the photoelectric conversion unit 111 for receiving the light flux that has passed through the first pupil region is first transferred to the reading unit 119, then output.

According to the foregoing configuration, it is possible to constantly acquire a picture signal with a high SN ratio, and the distance can be measured accurately. In particular, the distance to a dark object can be measured accurately.

Since the second signal corresponds to the sum of the signal charges accumulated in the two photoelectric conversion units 111, 112, it becomes the picture signal based on the light flux that has passed through the entire range of the exit pupil 105 of the taking lens 101. Thus, the object image (second image signal) can be acquired based on the second signal. In comparison to the case of individually transferring the signal charges accumulated in the two photoelectric conversion units 111, 112 to the reading unit and outputting the signal charges and thereafter adding the two signals to generate a picture signal, since the method of using the second signal enable reduction in the reading circuit noise, a high quality object image can be acquired.

In this embodiment, while the second transfer mode was used upon tentatively acquiring the image signals, the configuration is not limited thereto. The first transfer mode may also be used. Nevertheless, since noise reduction processing is not required when the second transfer mode is used, image signals can be acquired quicker. The signal charge of the photoelectric conversion unit with a higher transmission efficiency may also be transferred first to the reading unit, and the image signals may be generated without performing noise reduction processing.

Moreover, in step S103, the average value of the image signals with a greater signal intensity for each of the ranging pixels in the attention pixel region may also be used as the reliability.

Note that, in this embodiment, while a configuration of juxtaposing the photoelectric conversion units in the x direction as the ranging pixels was shown, the present invention is not limited thereto. Even in the case of adopting the configuration of juxtaposing the photoelectric conversion units in the y direction and acquiring the parallax image of the y direction, the photoelectric conversion unit to first read the signal charge may be determined according to the reliability of the statistical processing. Moreover, even in the case of adopting the configuration of disposing the photoelectric conversion units in the xy direction and acquiring the parallax image of the xy direction, the photoelectric conversion unit to first read the signal charge may be determined according to the reliability of the statistical processing.

Moreover, while a microlens was used as the light guiding means for guiding, to the photoelectric conversion unit, the light flux that has passed through a partial region on the exit pupil of the taking lens, the configuration is not limited thereto. Any means such as a waveguide or a prism capable of controlling the propagation of light may be used. In particular, when a waveguide is used, light guiding can be efficiently performed even in the case when the pixel size of the image pickup device is small.

### Embodiment 2

With the digital camera 100 in this embodiment, the transfer mode is dynamically determined for each pixel region in the image pickup device. Since the configuration of the digital camera 100 in this embodiment is the same as Embodiment 1, the explanation thereof is omitted. In the ensuing explanation, the signal reading control is mainly explained in detail.

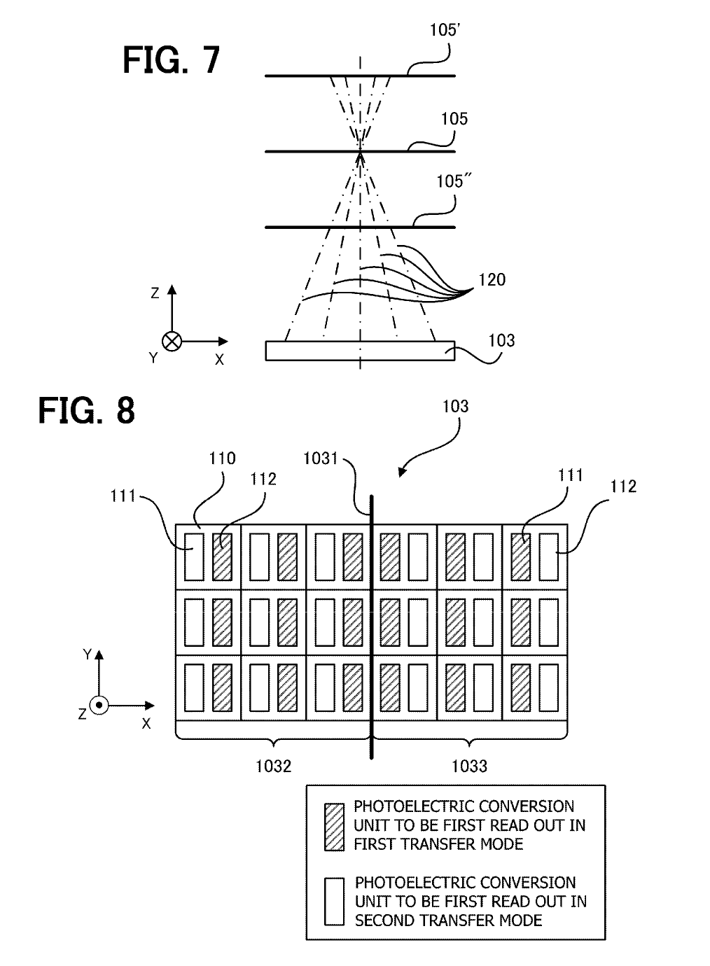

Even when there is no vignetting of the taking lens, when the taking lens is a zoom lens, the transmission efficiency will change since the position of the exit pupil in the optical axis direction will change. In the initial condition, as shown in FIG. 3, the optical axes 120 of the respective ranging pixels 110 in the image pickup device 103 all pass through the center point of the exit pupil 105. Nevertheless, when the zoom position changes, the position of the exit pupil in the optical axis direction also changes. When the position of the exit pupil 105′ differs from the exit pupil 105 in the initial condition, as shown in FIG. 7, the optical axes 120 of the ranging pixels 110 disposed in the periphery of the image pickup device 103 do not pass through the center point of the exit pupil 105′. Thus, the pupil region corresponding to the photoelectric conversion units 111, 112 in the ranging pixels 110 becomes decentered relative to the center point of the exit pupil 105′, and the transmission efficiency thereby changes.

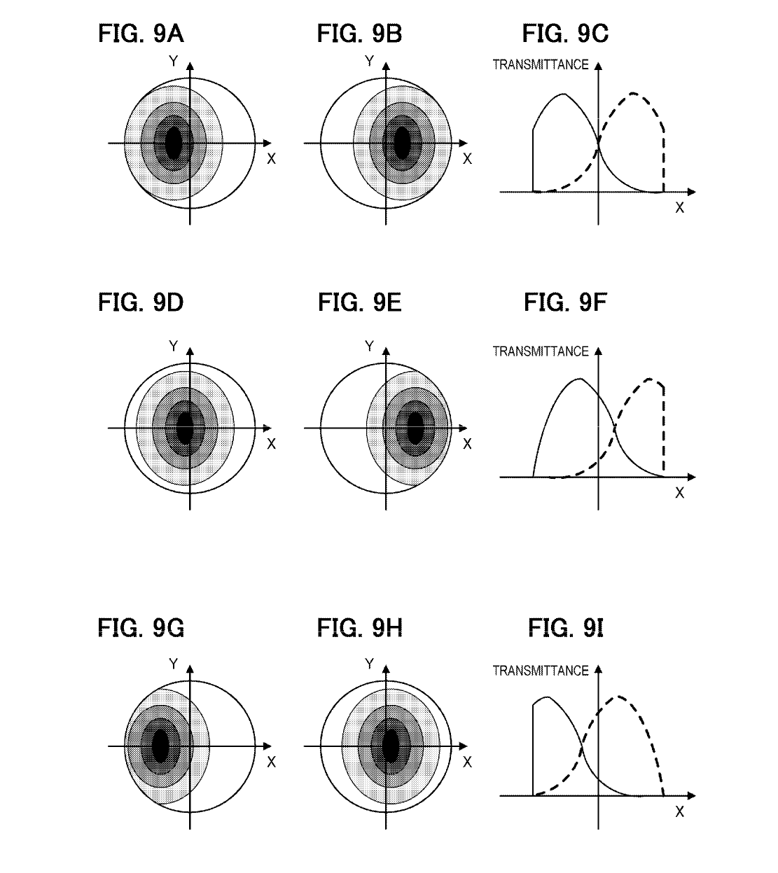

A case where the position of the exit pupil 105′ differs from the exit pupil 105 in the initial condition and is far from the image pickup device 103 and near the object is now explained in detail with reference to FIG. 8 and FIG. 9. FIG. 8 is a top view of the relevant part of the image pickup device 103, and the shaded photoelectric conversion unit is the photoelectric conversion unit (first photoelectric conversion unit) in which the signal is first read during the first transfer mode in the foregoing condition, and the non-shaded photoelectric conversion unit is the photoelectric conversion unit (first photoelectric conversion unit) in which the signal is first read during the second transfer mode in the foregoing condition. FIG. 9A represents the pupil transmittance distribution on the exit pupil 105′ corresponding to the photoelectric conversion unit 112 in the ranging pixels 110 disposed near the center of the image pickup device 103, and corresponds to the left eccentric pupil region (second pupil region). The darker the color, the higher the transmittance, and lighter the color, the lower the transmittance. Similarly, FIG. 9B represents the pupil transmittance distribution on the exit pupil 105′ corresponding to the photoelectric conversion unit 111 in the ranging pixels 110 disposed near the center of the image pickup device 103, and corresponds to the right eccentric pupil region (first pupil region). FIG. 9C represents the transmittance distribution on the x axial plane, and the horizontal axis shows the x axial coordinates and the vertical axis shows the transmittance. The solid line shows the transmittance distribution corresponding to the photoelectric conversion unit 112 (corresponding to the right eccentric pupil region), and the dotted line shows the transmittance distribution corresponding to the photoelectric conversion unit 111 (corresponding to the left eccentric pupil region).

The transmission efficiency in the respective pupil regions from the time that the light flux from the object enters the imaging optical system until the light flux reaches the photoelectric conversion unit is a value obtained by integrating the transmittance distribution in the exit pupil 105′ shown in FIGS. 9A and 9B. With the ranging pixels 110 disposed near the center of the image pickup device 103, the transmission efficiency of the right eccentric pupil region and the transmission efficiency of the left eccentric pupil region are substantially the same. Thus, the size of the object picture signals based on the light flux that passes through the respective pupil regions is substantially the same.

FIG. 9D represents the pupil transmittance distribution on the exit pupil 105′ corresponding to the photoelectric conversion unit 112 in the ranging pixels 110 of the image pickup device region 1032 shown in FIG. 8, and corresponds to the left eccentric pupil region (second pupil region). FIG. 9E represents the pupil transmittance distribution on the exit pupil 105′ corresponding to the photoelectric conversion unit 111 in the ranging pixels 110 of the image pickup device region 1032 shown in FIG. 8, and corresponds to the right eccentric pupil region (first pupil region). FIG. 9F represents the transmittance distribution on the x axial plane. Since the original transmittance distribution is decentered relative to the exit pupil, the transmission efficiency is different. As shown in FIG. 9D, when the eccentricity of the region with high transmittance relative to the center point of the pupil is small, the amount of decrease in the transmission efficiency is small. Meanwhile, as shown in FIG. 9E, when the eccentricity of the region with high transmittance relative to the center point of the pupil is great, the amount of decrease in the transmission efficiency is great. Thus, with the ranging pixels 110 of the image pickup device region 1032, the transmission efficiency of the left eccentric pupil region will be a value that is higher than the transmission efficiency of the right eccentric pupil region. In other words, the picture signal based on the light flux that has passed through the left eccentric pupil region will be greater than the picture signal based on the light flux that has passed through the right eccentric pupil region.

FIG. 9G represents the pupil transmittance distribution on the exit pupil 105′ corresponding to the photoelectric conversion unit 112 in the ranging pixels 110 of the image pickup device region 1033 shown in FIG. 8, and corresponds to the left eccentric pupil region (second pupil region). FIG. 9H represents the pupil transmittance distribution on the exit pupil 105′ corresponding to the photoelectric conversion unit 111 in the ranging pixels 110 of the image pickup device region 1033, and corresponds to the right eccentric pupil region (first pupil region). FIG. 9I represents the transmittance distribution on the x axial plane. Similarly, with the ranging pixels 110 of the image pickup device region 1033, the transmission efficiency of the right eccentric pupil region will be a value that is higher than the transmission efficiency of the left eccentric pupil region. Thus, the picture signal based on the light flux that has passed through the right eccentric pupil region will be greater than the picture signal based on the light flux that has passed through the left eccentric pupil region.

Meanwhile, when the position of the exit pupil 105″ differs from the exit pupil 105 in the initial condition and is near the image pickup device 103, the pupil region corresponding to the photoelectric conversion units 111, 112 in the ranging pixels 110 will be decentered to the opposite side relative to the center point of the exit pupil 105″ (FIG. 7). In the foregoing case, contrarily, with the ranging pixels 110 of the image pickup device region 1032, the transmission efficiency of the right eccentric pupil region will be a value that is higher than the transmission efficiency of the left eccentric pupil region. In other words, the picture signal based on the light flux that has passed through the right eccentric pupil region will be greater than the picture signal based on the light flux that has passed through the left eccentric pupil region. Moreover, with the ranging pixels 110 of the image pickup device region 1033, the transmission efficiency of the left eccentric pupil region will be a value that is higher than the transmission efficiency of the right eccentric pupil region. Thus, the picture signal based on the light flux that has passed through the left eccentric pupil region will be greater than the picture signal based on the light flux that has passed through the right eccentric pupil region.

When the position of the exit pupil of the taking lens changes according to the zoom position as described above, the size of the picture signal based on the light flux that has passed through the respective pupil regions will differ according to the photographing conditions in accordance with the positional relationship thereof. The photoelectric conversion unit that first transfers the signal charge to the reading unit in the respective transfer modes in the case when the exit pupil position is closer to the image pickup device side than the initial condition (105″ of FIG. 7) will be as follows.

In the first transfer mode, the signal charge accumulated in the photoelectric conversion unit 111 is first transferred to the reading unit and output in the image pickup device region 1032 of FIG. 8, and the signal charge accumulated in the photoelectric conversion unit 112 is first transferred to the reading unit and output in the image pickup device region 1033.

In the second transfer mode, the signal charge accumulated in the photoelectric conversion unit 112 is first transferred to the reading unit and output in the image pickup device region 1032 of FIG. 8, and the signal charge accumulated in the photoelectric conversion unit 111 is first transferred to the reading unit and output in the image pickup device region 1033.

Meanwhile, the photoelectric conversion unit that first transfers the signal charge to the reading unit in the respective transfer modes in the case when the exit pupil position is closer to the object side than the initial condition (105′ of FIG. 7) will be as follows.

In the first transfer mode, the signal charge accumulated in the photoelectric conversion unit 112 is first transferred to the reading unit and output with the ranging pixels 110 in the image pickup device region 1032 of FIG. 8, and the signal charge accumulated in the photoelectric conversion unit 111 is first transferred to the reading unit and output with the ranging pixels 110 in the image pickup device region 1033.

In the second transfer mode, the signal charge accumulated in the photoelectric conversion unit 111 is first transferred to the reading unit and output with the ranging pixels 110 in the image pickup device region 1032 of FIG. 8, and the signal charge accumulated in the photoelectric conversion unit 112 is first transferred to the reading unit and output with the ranging pixels 110 in the image pickup device region 1033.

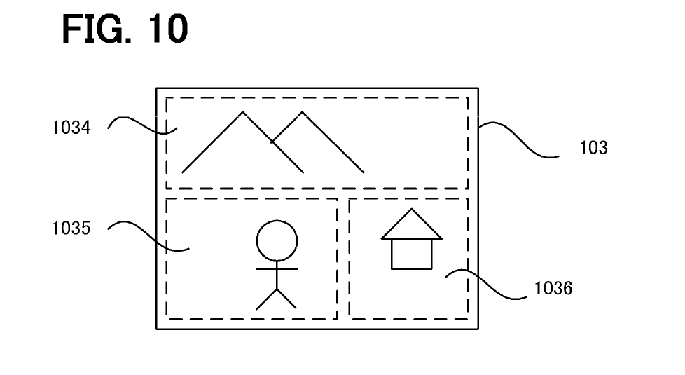

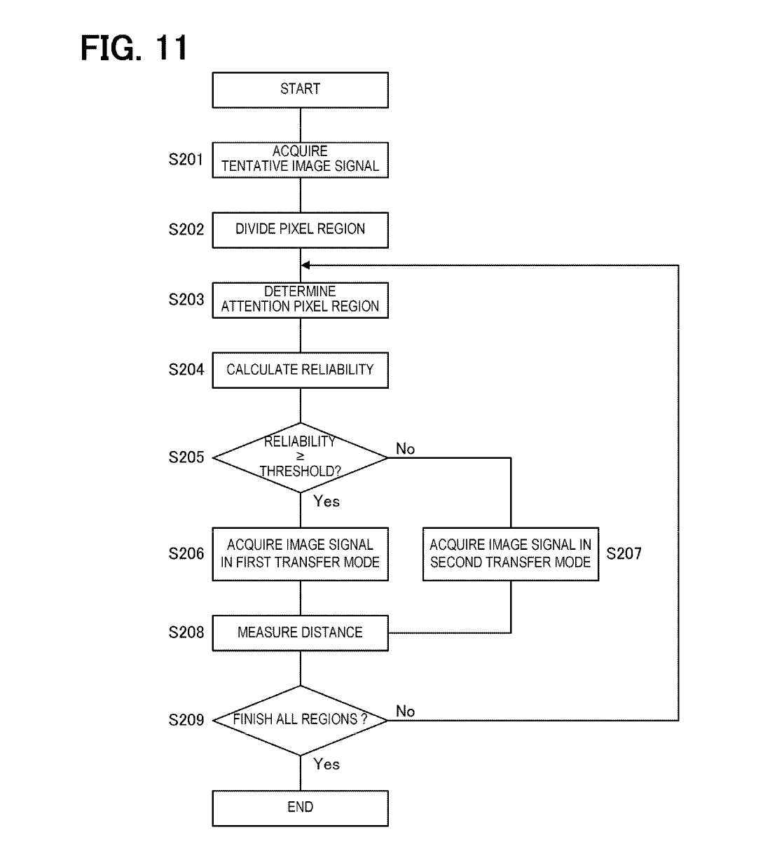

FIG. 11 shows the processing flow of this embodiment in a case where an object image is formed on the image pickup device 103 as shown in FIG. 10. Foremost, in step S201, the signals (tentative image signals) corresponding to the signal charge of the photoelectric conversion units 111 and 112 are tentatively acquired. While the transfer mode in this case may be arbitrarily selected, in this embodiment, the first image signal and the third image signal are acquired from the photoelectric conversion unit of the ranging pixels in the second transfer mode. In step S202, the control unit 104 divides the inside of the image pickup device 103 into a plurality of pixel regions (1034, 1035, 1036) based on the tentative image signals. The pixel region division is performed using conventional technology such as object separation or object recognition, such as facial recognition, based on the luminance level or hue. In step S203, the control unit 104 determines the attention pixel region from the plurality of resulting pixel regions.

In step S204, the control unit 104 calculates the reliability using the first image signal and the third image signal corresponding to the attention pixel region. Since image signals have very strong spatial correlation compared to other signals, by using the image signal of the adjacent pixel region and performing processing giving consideration to the continuity of luminance or hue, noise reduction can be performed. Here, the higher the similarity between the pixel signal of the attention pixel and the pixel signal of the adjacent pixel, the higher the effect of noise reduction. Thus, the similarity of the luminance level between the pixel signal of the attention pixel and the pixel signal of the adjacent pixel is calculated, and used as the reliability. When the luminance level is used as the index of similarity, the calculation can be performed using only the image signal of the G pixel of the RGB pixels and, therefore, the calculation load can be reduced, and the reliability can be calculated quickly. Hue information may also be used as the index of similarity. When hue information is used, while the calculation time will increase since the image signals of the R pixel and the B pixel are used in addition to the G pixel, the similarity can be determined with greater accuracy.

Subsequently, in step S205, the control unit 104 determines whether the reliability is greater than or equal to a predetermined threshold. When the reliability is greater than or equal to the threshold (S205—YES), the similarity between the image signal of the attention pixel and the image signal of the adjacent pixel is high enough, and the noise reduction effect based on the statistical processing is great. Accordingly, the first image signal and the third image signal are acquired from the photoelectric conversion unit of all ranging pixels in the image pickup device in the first transfer mode (S206). When the reliability is less than the threshold (S205—NO), the similarity between the image signal of the attention pixel and the image signal of the adjacent pixel is low, and the noise reduction effect based on the statistical processing is limited. Accordingly, the first image signal and the third image signal are acquired from the photoelectric conversion unit of all ranging pixels in the image pickup device in the second transfer mode (S207). Subsequently, in step S208, the control unit 104 calculates the image deviation from the first image signal and the third image signal, and thereby measures the distance to the object. In step S208, whether all pixel regions have been processed is determined, and the routine returns to step S203 when all pixels have not been processed, and a different pixel region is selected and subjected to the same processing.

According to the foregoing configuration, it is possible to constantly acquire picture signals with a high SN ratio, and measure the distance with high accuracy. Particularly, it is possible to accurately measure the distance to a dark object.

Note that the ranging pixels may be disposed on the entire surface of the image pickup device, or disposed on a partial region. Moreover, the position of the focusing lens may be controlled for performing auto-focus operations or the image may be processed such as by adding a blur according to the distance from the focusing plane based on the distance information acquired with the depth measurement apparatus of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-121179, filed on Jun. 7, 2013, which is hereby incorporated by reference herein in its entirety.

What is claimed is:

1. A depth measurement apparatus, comprising:
an imaging optical system;
an image pickup device which includes ranging pixels each having a photoelectric conversion unit for receiving a light flux that has passed through a first pupil region of the imaging optical system and a photoelectric conversion unit for receiving a light flux that has passed through a second pupil region, that is different from the first pupil region, of the imaging optical system
a reading unit that is shared by a plurality of photoelectric conversion units in the ranging pixels; and
a control unit configured to control the ranging operation, wherein
the control unit is configured so that a signal charge accumulated in a first photoelectric conversion unit among the plurality of photoelectric conversion units is transferred to the reading unit, and a first signal corresponding to the signal charge accumulated in the first photoelectric conversion unit is output,
the control unit is configured so that a signal charge accumulated in a second photoelectric conversion unit that is different from the first photoelectric conversion unit is transferred and added to the reading unit, and a second signal corresponding to a sum of the signal charges accumulated in the first and second photoelectric conversion units is output,
a first transfer mode and a second transfer mode are selectable and the first and second signals are each output in one of the transfer modes, the first transfer mode being a mode in which, from among the photoelectric conversion unit for receiving the light flux that has passed through the first pupil region and the photoelectric conversion unit for receiving the light flux that has passed through the second pupil region, the photoelectric conversion unit receiving light flux with a higher transmittance in a travel path from an object to the photoelectric conversion unit is used as the first photoelectric conversion unit, and the second transfer mode being a mode in which the photoelectric conversion unit receiving light flux with a lower transmittance is used as the first photoelectric conversion unit,
the control unit is configured so that when the first transfer mode is selected, a first image signal obtained by performing noise reduction processing to an image signal generated from the first signal and a second image signal obtained by performing noise reduction processing to an image signal generated from the second signal are generated, and a third image signal corresponding to the signal charge accumulated in the second photoelectric conversion unit is generated by subtracting the first image signal from the second image signal,
the control unit is configured so that when the second transfer mode is selected, a third signal corresponding to the signal charge accumulated in the second photoelectric conversion unit is generated based on a difference between the second signal and the first signal, a first image signal is generated from the first signal, and a third image signal is generated from the third signal, and
a distance to the object is measured based on an image shift amount between the first image signal and the third image signal.

2. The depth measurement apparatus according to claim 1, wherein
tentatively, signals corresponding to the signal charge accumulated in the respective photoelectric conversion units of the ranging pixels are acquired, image signal reliability is determined based on the first image signal and the third image signal, and the transfer mode for distance measurement is thereby selected.

3. The depth measurement apparatus according to claim 2, wherein
upon tentatively acquiring signals corresponding to the signal charge accumulated in the respective photoelectric conversion units of the ranging pixels, the acquisition is performed in the second transfer mode.

4. The depth measurement apparatus according to claim 2, wherein
the transfer mode in the entire image pickup device is selected based on the reliability of an attention pixel region in the image pickup device.

5. The depth measurement apparatus according to claim 2, wherein
the reliability is determined for each of a plurality of divided pixel regions, and the transfer mode is selected for each of the divided pixel regions.

6. The depth measurement apparatus according to claim 2, wherein
the reliability is a signal intensity value of a greater signal intensity of either a signal intensity of the first image signal or a signal intensity of the third image signal, and
the first transfer mode is selected when the reliability is a predetermined threshold or higher, and the second transfer mode is selected when the reliability is less than the threshold.

7. The depth measurement apparatus according to claim 2, wherein
the reliability is a similarly of the first image signal or the third image signal in an attention pixel region and an adjacent pixel region that is adjacent to the attention pixel region, and
the first transfer mode is selected when the reliability is a predetermined threshold or higher, and the second transfer mode is selected when the reliability is less than the threshold.

8. The depth measurement apparatus according to claim 7, wherein
the similarity is a similarity of a luminance level of the image signal in the attention pixel region and the adjacent pixel region.

9. The depth measurement apparatus according to claim 7, wherein
the similarity is a similarity of a hue of the image signal in the attention pixel region and adjacent pixel region.

10. An imaging apparatus comprising the depth measurement apparatus according to claim 1,
the imaging apparatus acquiring an object image based on the second signal.

11. A method of controlling a depth measurement apparatus comprising:
an imaging optical system;
an image pickup device which includes ranging pixels each having a photoelectric conversion unit for receiving a light flux that has passed through a first pupil region of the imaging optical system and a photoelectric conversion unit for receiving a light flux that has passed through a second pupil region, that is different from the first pupil region, of the imaging optical system; and
a reading unit that is shared by a plurality of photoelectric conversion units in the ranging pixels,
the method comprising the steps of:
transferring a signal charge accumulated in a first photoelectric conversion unit among the plurality of photoelectric conversion units to the reading unit, and outputting a first signal corresponding to the signal charge accumulated in the first photoelectric conversion unit; and
transferring and adding a signal charge accumulated in a second photoelectric conversion unit that is different from the first photoelectric conversion unit to the reading unit, and outputting a second signal corresponding to a sum of the signal charges accumulated in the first and second photo electric conversion units,
a first transfer mode and a second transfer mode being selectable, the first transfer mode being a mode in which, from among the photoelectric conversion unit for receiving the light flux that has passed through the first pupil region and the photoelectric conversion unit for receiving the light flux that has passed through the second pupil region, the photoelectric conversion unit receiving light flux with a higher transmittance in a travel path from an object to the photoelectric conversion unit is used as the first photoelectric conversion unit, and the second transfer mode being a mode in which the photoelectric conversion unit receiving light flux with lower transmittance is used as the first photoelectric conversion unit,
the method further comprising the steps of:
determining the transfer mode upon outputting the first and second signals;
generating a first image signal obtained by performing noise reduction processing to an image signal generated from the first signal and a second image signal obtained by performing noise reduction processing to an image signal generated from the second signal, and generating a third image signal corresponding to the signal charge accumulated in the second photoelectric conversion unit by subtracting the first image signal from the second image signal when the first transfer mode is selected;
generating a third signal corresponding to the signal charge accumulated in the second photoelectric conversion unit based on a difference between the second signal and the first signal, generating a first image signal from the first signal, and generating a third image signal from the third signal when the second transfer mode is selected; and
measuring a distance to the object based on an image shift amount between the first image signal and the third image signal.

12. The method of controlling a depth measurement apparatus according to claim 11, wherein,
in the step of determining the transfer mode, tentatively, signals corresponding to the signal charge accumulated in the respective photoelectric conversion units of the ranging pixels are acquired, image signal reliability is determined based on the first image signal and the third image signal, and the transfer mode for distance measurement is thereby selected.

13. The method of controlling a depth measurement apparatus according to claim 12, wherein
upon tentatively acquiring signals corresponding to the signal charge accumulated in the respective photoelectric conversion units of the ranging pixels, the acquisition is performed in the second transfer mode.

14. The method of controlling a depth measurement apparatus according to claim 12, wherein
in the step of determining the transfer mode, the transfer mode in the entire image pickup device is selected based on the reliability of an attention pixel region in the image pickup device.

15. The method of controlling a depth measurement apparatus according to claim 12, wherein
in the step of determining the transfer mode, the reliability is determined for each of a plurality of divided pixel regions, and the transfer mode is selected for each of the divided pixel regions.

16. The method of controlling a depth measurement apparatus according to claim 12, wherein
the reliability is a signal intensity value of a greater signal intensity of either a signal intensity of the first image signal or a signal intensity of the third image signal, and
in the step of determining the transfer mode, the first transfer mode is selected when the reliability is a predetermined threshold or higher, and the second transfer mode is selected when the reliability is less than the threshold.

17. The method of controlling a depth measurement apparatus according to claim 12, wherein
the reliability is a similarly of the first image signal or the third image signal in an attention pixel region and an adjacent pixel region that is adjacent to the attention pixel region, and
in the step of determining the transfer mode, the first transfer mode is selected when the reliability is a predetermined threshold or higher, and the second transfer mode is selected when the reliability is less than the threshold.

18. The method of controlling a depth measurement apparatus according to claim 17, wherein
the similarity is a similarity of a luminance level of the image signal in the attention pixel region and the adjacent pixel region.

19. The method of controlling a depth measurement apparatus according to claim 17, wherein
the similarity is a similarity of a hue of the image signal in the attention pixel region and the adjacent pixel region.
